(19) United States
(12) Patent Application Publication
(10) Pub. No.: US 2025/0319698 A1
(43) Pub. Date: Oct. 16, 2025

(54) INKJET CHIP STRUCTURE

(71) Applicant: Microjet Technology Co., Ltd., Hsinchu (TW)

(72) Inventors: Hao-Jan Mou, Hsinchu (TW); Cheng-Ming Chang, Hsinchu (TW); Wen-Hsiung Liao, Hsinchu (TW)

(73) Assignee: Microjet Technology Co., Ltd., Hsinchu (TW)

(21) Appl. No.: 19/098,383

(22) Filed: Apr. 2, 2025

(30) Foreign Application Priority Data
Apr. 16, 2024 (TW) 113114201
Apr. 18, 2024 (TW) 113114548
Apr. 25, 2024 (TW) 113115578
May 14, 2024 (TW) 113117767

(51) Int. Cl. B41J 2/14; B41J 2/045

(52) U.S. Cl. CPC B41J 2/14129; B41J 2/0455; B41J 2/14072; B41J 2/1412; B41J 2/0458

(57) ABSTRACT

The present disclosure provides an chip structure. The inkjet chip structure includes a substrate layer, a heating resistor, and a protective layer. The heating resistor is disposed on the substrate layer. The protective layer covers the heating resistor. The heating resistor includes a heating resistance layer and a dielectric layer. The protective layer includes a plurality of recesses disposed above the dielectric layer. A distance is formed from a bottom of the recess to a top of the heating resistance layer, and the distance is ranged from 1.5×10⁻⁷ m to 1.4×10⁻⁶ m. In addition, a contact layer is arranged around the heating resistance layer. The contact layer is rectangular in shape when viewed from a top view. There are at least two contact layers in each direction from the heating resistance layer, and all the contact layers have one side length with a fixed size.

### CROSS-REFERENCE TO RELATED APPLICATION

This application claims priorities to Taiwan Patent Application No. 113114201, filed on Apr. 16, 2024, Taiwan Patent Application No. 113114548, filed on Apr. 18, 2024, Taiwan Patent Application No. 113115578, filed on Apr. 25, 2024, and Taiwan Patent Application No. 113117767, filed on May 14, 2024. The entire contents of the above-mentioned patent applications are incorporated herein by reference for all purposes.

### FIELD OF THE INVENTION

The present disclosure relates to an inkjet chip structure, and more particularly to an inkjet chip structure for increasing the overall device strength, the electrical properties and the printing performance thereof by improving the conductive layer and the heating resistance layer, and optimizing the upper structure and the related specifications of the protective layer.

### BACKGROUND OF THE INVENTION

Inkjet printing technology, often referred to as “Inkjet Printing”, is a widely used printing technology. The history of inkjet printing with its origins tracking back to the 1950s when the British component of HP (Hewlett-Packard) invented inkjet printing technology. Since then, the inkjet printing technology has developed rapidly, and the inkjet printers have become the mainstream technology for home and commercial printing. The inkjet printers have many advantages, such as the cost-effectiveness, especially for home and small business use. Also, the inkjet printers have high printing quality, and can provide high-resolution and high-quality images, especially in photos or pictures. Furthermore, the inkjet printers are convenient to use and easy to install, most of inkjet printers can print through computers or mobile devices. In addition, the combination of the inkjet printers and a business machines with all-in-one functions (including fax, photocopying, and scanning) that have emerged in recent years can quickly expand the flexibility of paperwork in the office.

The operating principle of an inkjet printer is to spray tiny dots of ink onto a paper or a recording media to output the text or images. With the rapid development of digital imaging, the demand for high-resolution inkjet printing is gradually increase. In order to control more dots to provide printing resolution, the inkjet head technology has evolved from traditional single-dot control to metal-oxide semiconductor field-effect transistor (MOSFET) control. In more details, please refer to FIG. 1, which shows an inkjet wafer structure 100 according to the the prior art. The conventional inkjet chip structure 100 generally includes a nozzle 101, a barrier layer 103, a protective layer 104, a conductive layer 105, a heating resistance layer 106, and a thermal barrier layer 107, which are sequentially stacked to form a stacked structure of the inkjet wafer structure 100. An ink supply chamber 102 is formed between the protective layer 104 and the barrier layer 103. A portion of the conductive layer 105 is formed on the heating resistance layer 106, so that the conductive layer 105 contacts the heating resistance layer 106 in a two-layer inclined step shape (as shown in the dotted circle in FIG. 1). The conductive layer 105 provides the electrical energy to the heating resistance layer 106, so that the ink in the ink supply chamber 102 is heated to generate bubbles, and finally ejected from the nozzle.

In the conventional inkjet chip structure 100, the conductive layer 105 and the heating resistance layer 106 are plated by sputtering during the manufacturing process. After the corresponding MOSFET control element is completed, the required size and shape are defined by yellow light and etching processes. However, in the process of defining the size range, the above-mentioned two-layer inclined step shape is generated at the junction of the conductive layer 105 and the heating resistance layer 106 due to erosion, and several inherent structural problems such as stress concentration and poor step coverage are caused by the two-layer inclined step in the inkjet chip structure 100 easily.

Furthermore, during the printing process, the heating resistance layer 106 and the conductive layer 105 at the bottom of the ink supply chamber 102 for heating the ink need to work in an environment of high current, high temperature, mechanical impact and chemical erosion of the ink. Since the two-layer inclined step structure of the heating resistance layer 106 and the conductive layer 105 has a problem of poor physical mechanical strength, it is easy to produce cracks or holes at the junction of the step structure in practice. This further causes the protective layer 104 nearby the step structure to crack. As a result, the ink penetrates into the inkjet chip, causing the damage to the components, resulting in poor service life or reliability of the conventional inkjet chip structure 100. The performance of inkjet printing is affected directly. Therefore, in the current market, there is still an urgent need to further explore the relationship between the conventional inkjet chip structure 100 and the corresponding specifications in terms of printing performance and production yield.

### SUMMARY OF THE INVENTION

Based on the above reasons, an object of the present disclosure is to provide a inkjet chip structure to improve the two-layer inclined step structure at the junction of the heating resistance layer and the conductive layer in the heating structure thereof. By integrating the above two on the same layer of material, the protective layer is formed subsequently thereon, and the step phenomenon can be eliminated. Thereby, the mechanical strength, service life and reliability of the inkjet chip structure are improved. In addition, the upper structure of the heating resistance layer and the dielectric layer is optimized in the present disclosure. That is, the protective layer is disposed thereon to form a concave structure, so that the efficiency of the heating resistance layer in heating the ink is improved. In addition to the physical structural strength, the energy efficiency is improved according to the present disclosure. At the same time, in response to the printing and production of new inkjet chip structure, the present disclosure also provides the specifications related to inkjet chip. It allows the inkjet chip structure of the present disclosure maintaining the quality of traditional inkjet printing while further balancing energy saving and production yield. In general, the inkjet chip structure of the present disclosure is improved to obtain a better structural integration, so that the performances of the inkjet chip structure in subsequent simultaneous printing, such as the number of dots controlled, printing mode processing, brightness control, saturation control, energy saving, and production yield are enhanced, and the requirements for manufacturing processes and additional manufacturing costs are more effectively reduced. The detailed technical features are described hereafter.

In accordance with an aspect of the present disclosure, an inkjet chip structure is provided and includes a substrate, a heating resistor, a protective layer and a plurality of contact layers. The substrate layer is configured to carry components of the inkjet chip structure. The heating resistor is arranged on the substrate layer for heating an ink. The heating resistor further includes a heating resistance layer and a dielectric layer.

The dielectric layer encapsulates the heating resistance layer therein. The protective layer covers the heating resistor, and the protective layer includes a plurality of recesses (i.e., the portion of the heating resistor not covered by the protective layer). A distance is formed from a bottom of the recess to a top of the heating resistance layer. The distance is ranged from 1.5×10⁻⁷ m to 1.4×10⁻⁶ m and it enables the inkjet chip structure to achieve the energy saving and improve the production yield. The plurality of contact layers are electrically connected to the heating resistor to control the heating of the ink during the printing process. In addition, the contact layers have a rectangular configuration in view of a top-down perspective and are arranged around the heating resistor. There are more than two (including two) contact layers in each direction from the heating resistor. The connecting layer is viewed from a top-down perspective. Each of the plurality of contact layers has one side length with a fixed size, so that the heating resistor can obtain energy more efficiently, and the inkjet chip structure can achieve the purposes of energy saving, improving production yield and extending service life.

In an embodiment, the heating resistor further includes a first oxide layer, a conductive layer and a control layer. The first oxide layer is arranged on the substrate layer. The conductive layer is arranged on the first oxide layer. The control layer partially covers the dielectric layer. The heating resistance layer is arranged on the first oxide layer. The heating resistance layer is disposed adjacent to and in contact with the conductive layer, and located at an identical horizontal position of the conductive layer. The conductive layer and the heating resistance layer cover a partial surface of the first oxide layer. In addition, the dielectric layer partially covers the first oxide layer and encapsulates the heating resistance layer and the conductive layer therein.

In an embodiment, a part of the protective layer is covered by the dielectric layer to encapsulate the control layer therein. The other part of the protective layer not covered by the dielectric layer forms the above-mentioned recess on the protective layer. The height of the recess is defined by a first surface of the upper end of the protective layer and a second surface of the upper end of the dielectric layer. In addition, the control layer receives a control signal from a signal terminal and is electrically connected to the conductive layer and the contact layer to control the heating resistance layer to heat the ink during the printing process.

In an embodiment, the protective layer further includes a plurality of protective layers covering the heating resistor, the plurality of protective layers include a plurality of recesses, and the plurality of protective layers further include a first protective layer directly arranged on the heating resistor, wherein the first protective layer is an insulation material; and a plurality of contact layers are electrically connected to the heating resistor.

In an embodiment, the signal terminal is an external signal terminal from outside the inkjet chip structure, or an internal signal terminal integrated into the inkjet chip structure. In one embodiment of the present disclosure, in case of that the signal terminal is an internal signal terminal, the internal signal terminal is a control transistor and electrically connected to the control layer, so that the control transistor can control the heating resistance layer to heat the ink during the printing process.

In an embodiment, the control transistor is a metal-oxide semiconductor field-effect transistor (MOSFET), wherein the control transistor is selected from an N-type metal-oxide semiconductor field-effect transistor (N-MOSFET) or a P-type metal-oxide semiconductor field-effect transistor (P-MOSFET).

In an embodiment, the plurality of contact layers included in the inkjet chip structure are arranged on the conductive layer and the control transistor, and electrically connected to the control layer, so that the control transistor can control the heating resistance layer to heat the ink during the printing process.

In an embodiment, in case of that the control transistor is a MOSFET, the control transistor includes a source, a drain and a gate. The source and the drain are embedded in the substrate layer, and the gate is arranged on the substrate layer to control the source and the drain for opening and closing, so that the control transistor is controlled and operated.

In an embodiment, the gate further includes a second oxide layer and a polysilicon layer stacked in sequence on the substrate layer.

### BRIEF DESCRIPTION OF THE DRAWING

The following detailed descriptions of the present disclosure and the schematic diagrams of the embodiments should enable the present disclosure to be more fully understood. However, it should be understood that this is only used as a reference for understanding the application of the present disclosure, rather than limiting the present disclosure to a specific embodiment.

FIG. 1 is a schematic diagram illustrating a conventional inkjet chip structure according to the prior art;

FIG. 2A is a schematic diagram illustrating a stacked inkjet chip structure according to an embodiment of the present disclosure;

FIG. 2B is a schematic diagram illustrating the structure of the heating resistor according to the embodiment of the present disclosure;

FIG. 3 is a schematic diagram illustrating the conductive layer integrated with the heating resistance layer according the embodiment of the present disclosure;

FIG. 4A and FIG. 4B are schematic diagrams illustrating the protective layer optimized according to the embodiment of the present disclosure;

FIG. 4C is a schematic diagram illustrating the conductive layer integrated with the heating resistance layer according to the embodiment of the present disclosure;

FIG. 5A is a top view illustrating the arrangement of the contact layer on the inkjet chip structure;

FIG. 5B is a top view illustrating a rectangular structure of the contact layer and the corresponding size conditions thereof;

FIG. 6A is a top view illustrating the relationship between the area of the monochrome inkjet and that of the recesses; and

FIG. 6B is a top view illustrating the relationship between the area of the multi-color inkjet chip and that of the recesses.

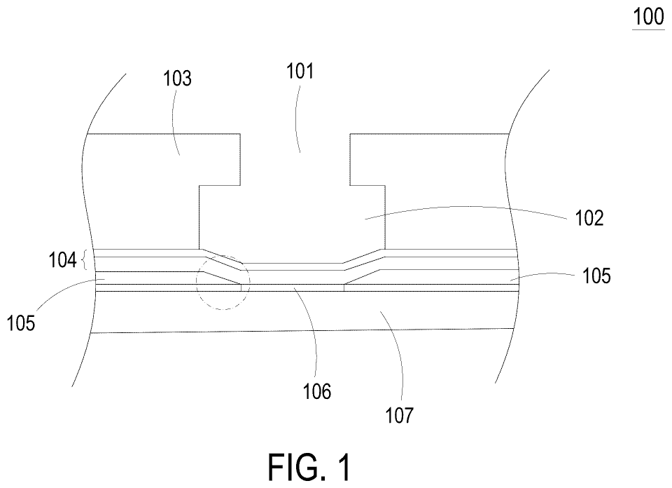

### DETAILED DESCRIPTION OF THE PREFERRED EMBODIMENT

The present disclosure will be described in detail with preferred embodiments and viewpoints. The following descriptions provide the specific implementation details of the present disclosure, so that how these embodiments are implemented can be fully understood. One skilled in the art will appreciate that the present disclosure may be practiced without these specific details. In addition, the present disclosure may also be used and implemented through other specific embodiments. The details described in the specification may also be applied based on different needs, and various modifications or changes may be made without departing from the spirit of the present disclosure. Therefore, the present disclosure will now be described more specifically with reference to the following embodiments. It is to be noted that the following descriptions of preferred embodiments of this invention are presented herein for purpose of illustration and description only. It is not intended to be exhaustive or limited to the precise embodiments disclosed. In the present disclosure, a first side length and a second side length are used to describe the size specifications of the rectangular contact layer in the present disclosure, the first side length and the second side length are collectively referred to as the side lengths. Those skilled in the art can easily understand the relevant description after reading the descriptions of the present disclosure and comparing it with the corresponding drawings, which is explained here in advance. Finally, the terminology used in the following descriptions is to be interpreted in the broadest reasonable manner to enable it to be used in conjunction with the detailed description of a particular embodiment of the present disclosure.

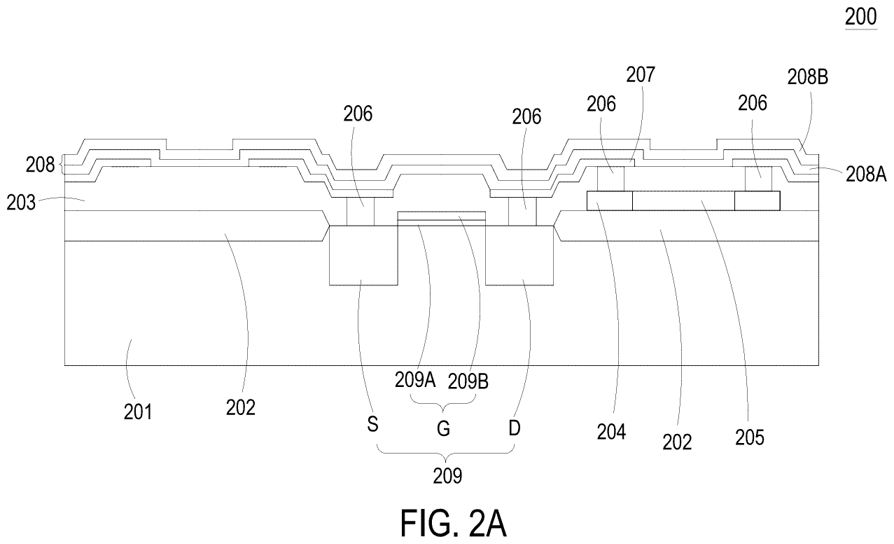

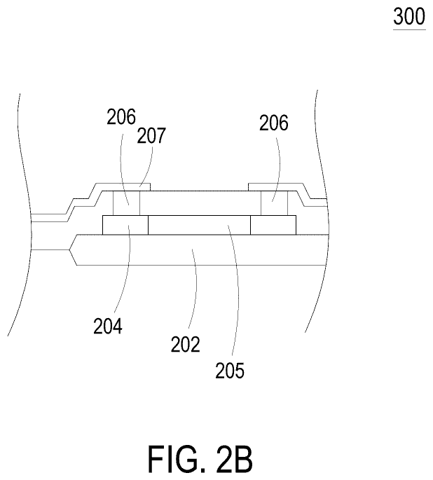

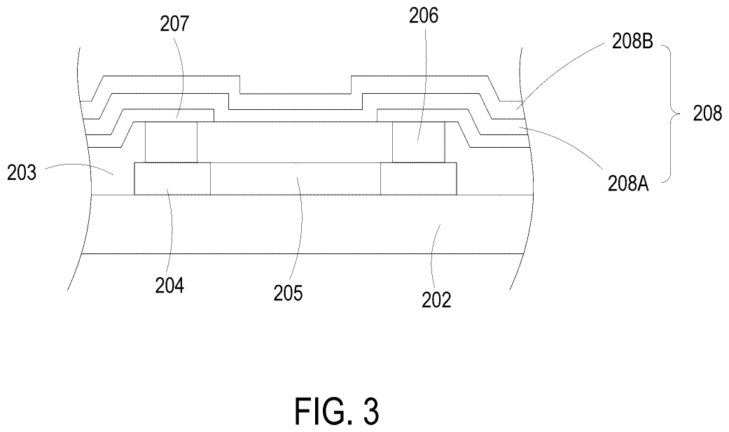

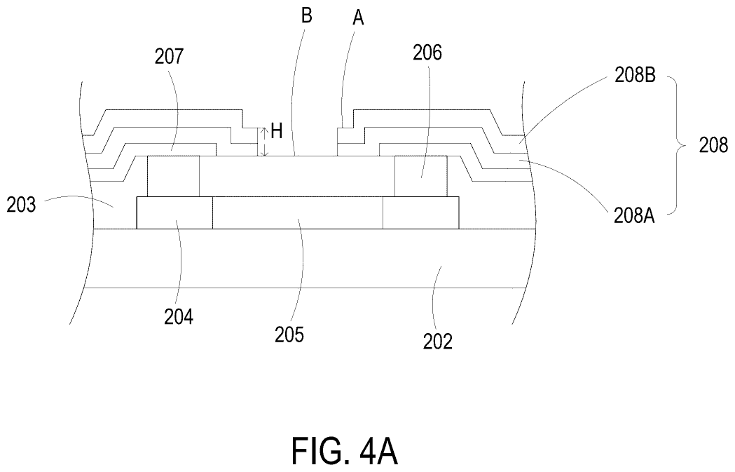

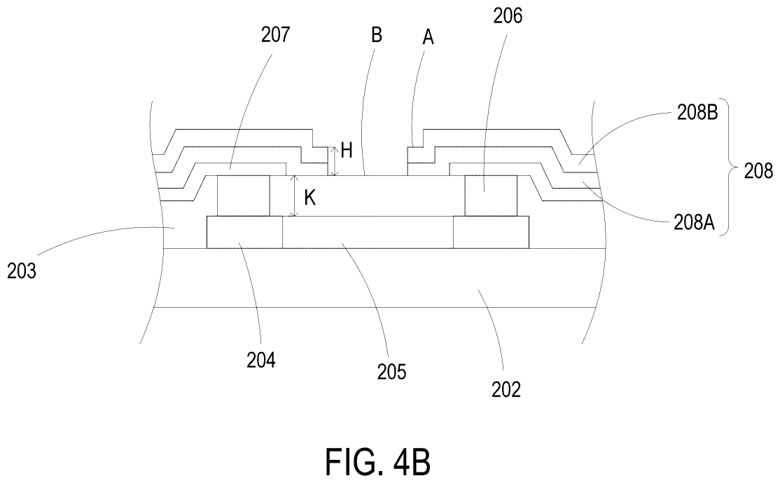

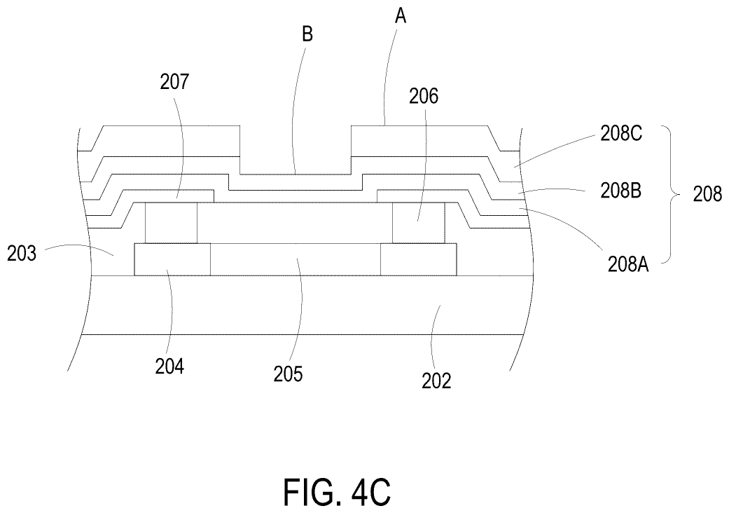

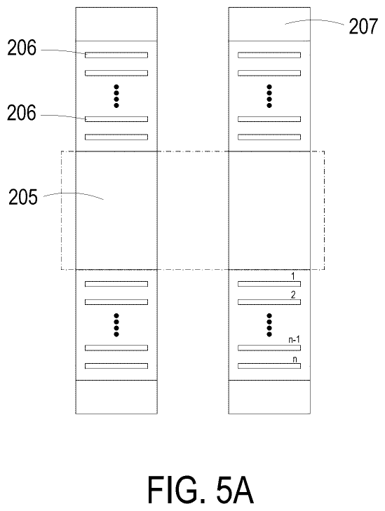

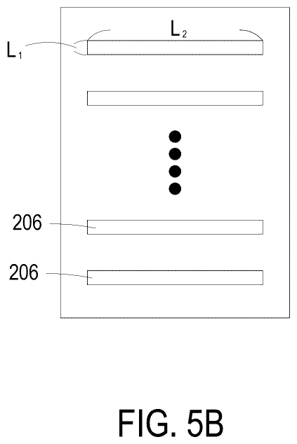

Please refer to FIG. 2A, FIG. 2B, FIG. 3, FIG. 4B, FIG. 5A and FIG. 5B. In order to improving the conventional technology, the present disclosure provides a novel inkjet chip structure 200. The inkjet chip structure 200 includes a substrate 201, a heating resistor 300, a protective layer 208 and a plurality of contact layers 206. The substrate layer 201 is configured to carry components of the inkjet chip structure 200. The heating resistor 300 is arranged on the substrate layer 201 for heating an ink. The heating resistor 300 further includes a heating resistance layer 205 and a dielectric layer 203. The dielectric layer 203 encapsulates the heating resistance layer 205 therein. The protective layer 208 covers the heating resistor 300. The protective layer 208 includes a plurality of recesses (i.e., the portion of the heating resistor 300 not covered by the protective layer 208). A distance K is formed from a bottom of the recess to a top of the heating resistance layer 205. The distance K is ranged from 1.5×10⁻⁷ m to 1.4×10⁻⁶ m and it enables the inkjet chip structure 200 to achieve the energy saving and improve the production yield.

In the embodiment, the plurality of contact layers 206 are electrically connected to the heating resistor 300 to control the heating of the ink during the printing process. In addition, as shown in FIG. 5A and FIG. 5B illustrating the inkjet chip structure 200 in view of a top-down perspective, there are N contact layers (N≥2) arranged adjacently in each direction from each heating resistor 300. Preferably but not exclusively, in the embodiment of FIG. 5A, there are one to n contact layers arranged at the lower right corner of each heating resistor 300. Similarly, there are one to N contact layers arranged at the upper right corner, upper left corner and lower left corner of each heating resistor 300. In the embodiment, each of the plurality of contact layers 206 viewed from a top-down perspective has one side length with a fixed size. That is to say, in FIG. 5B, each contact layer 206 presents the aforementioned rectangular configuration, and has a first side length L₁ and a second side length L₂, and one of the first side length L₁ and the second side length L₂ is a fixed size in all the contact layers 206, so that the inkjet chip structure 200 can achieve the purposes of energy saving, improving production yield and extending service life.

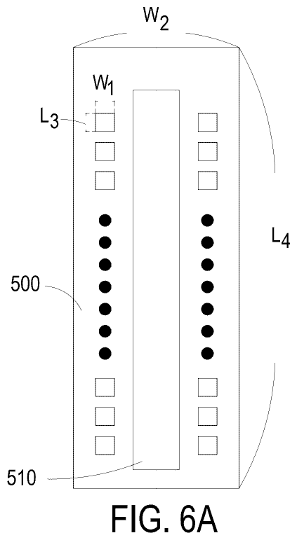

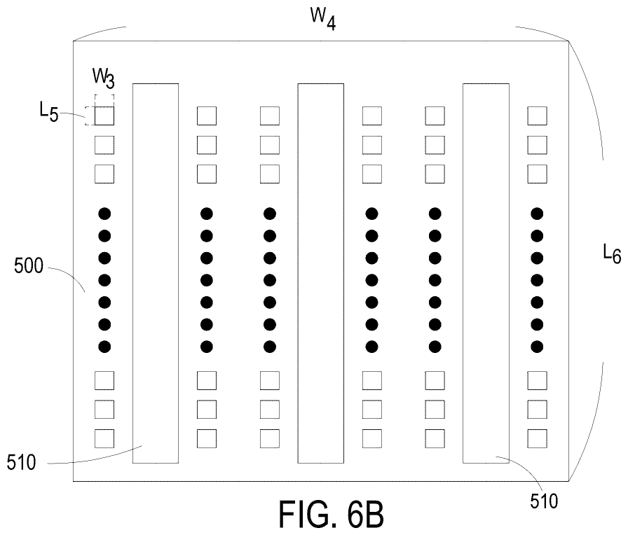

Please refer to FIG. 2A, FIG. 2B, FIG. 3, FIG. 4A, FIG. 4B and FIG. 6A. In an embodiment of the present disclosure, the novel inkjet chip structure 200 can be applied to a monochrome inkjet chip 500. The monochrome inkjet chip 500 has an ink supply aperture 510 corresponding to the ink color of the inkjet chip 500, and includes a substrate 201, a heating resistor 300, a protective layer 208. The substrate layer 201 is configured to carry components of the inkjet chip structure 200. The heating resistor 300 is arranged on the substrate layer 201 for heating an ink. The heating resistor 300 further includes a heating resistance layer 205 and a dielectric layer 203. The dielectric layer 203 encapsulates the heating resistance layer 205 therein. The protective layer 208 covers the heating resistor 300. The protective layer 208 includes a plurality of recesses (i.e., the portion of the heating resistor 300 not covered by the protective layer 208) disposed on the top. In the embodiment, the inkjet chip 500 has a second width W₂ and a second length L₄, and the above-mentioned recess has a first width W₁ and a first length L₃. A ratio of a total surface area of the plurality of recesses to a surface area of the inkjet chip 500 is less than 20%. That is, the first width W₁, the first length L₃, the number N of the recesses, the second width W₂, and the second length L₄ have the following mathematical relationship:

$$\frac{{NL}_{3} {w}_{1}}{{L}_{4} {w}_{2}} \times 100 \% \leq 20 \%$$

Please refer to FIG. 2A, FIG. 2B, FIG. 3, FIG. 4A, FIG. 4B and FIG. 6B. In an embodiment of the present disclosure, the novel inkjet chip structure 200 can be applied to a multi-color (two or more colors) inkjet chip 500. The multi-color inkjet chip 500 has a plurality of ink supply apertures 510 corresponding to the ink color of the inkjet chip 500, respectively. The multi-color inkjet chip 500 includes a substrate 201, a heating resistor 300, a protective layer 208. The substrate layer 201 is configured to carry components of the inkjet chip structure 200. The heating resistor 300 is arranged on the substrate layer 201 for heating an ink. The heating resistor 300 further includes a heating resistance layer 205 and a dielectric layer 203. The dielectric layer 203 encapsulates the heating resistance layer 205 therein. The protective layer 208 covers the heating resistor 300. The protective layer 208 includes a plurality of recesses (i.e., the portion of the heating resistor 300 not covered by the protective layer 208) disposed on the top. In the embodiment, the inkjet chip 500 has a fourth width W₄ and a fourth length L₄, and the above-mentioned recess has a third width W₃ and a third length L₅. A ratio of a total surface area of the plurality of recesses to a surface area of the inkjet chip 500 is less than 25%. That is, the third width W₃, the third length L₅, the number N of the recesses, the fourth width W₄, and the fourth length L₆ have the following mathematical relationship:

$$\frac{{NL}_{5} {w}_{3}}{{L}_{6} {w}_{4}} \times 100 \% \leq 25 \%$$

In the embodiment, the heating resistor 300 further includes a first oxide layer 202, a conductive layer 204 and a control layer 207. The first oxide layer 202 is disposed on the substrate layer 201. The conductive layer 202 is disposed on the first oxide layer 202. The control layer 207 partially covers the dielectric layer to receives a control signal from a signal terminal, and is electrically connected to the conductive layer 204 and the contact layer 206 to control the heating resistance layer 205 for heating the ink during the printing process. In addition, the heating resistance layer 205 is disposed on the first oxide layer 202, arranged adjacent to and in contact with the conductive layer 204, located at an identical horizontal position of the conductive layer 204 and covering a partial surface of the first oxide layer 202. In the embodiment, the dielectric layer 203 partially covers the first oxide layer 202 and encapsulates the heating resistance layer 205 and the conductive layer 204 therein. Furthermore, in the inkjet chip structure 200, a part of the protective layer 208 is covered by the dielectric layer 207 to encapsulate the control layer 207 therein. The other part of the protective layer 208 not covered by the dielectric layer 207 forms the above-mentioned recess on the protective layer 208. According to an aspect of the present disclosure, the heating resistance layer 205 and the conductive layer 204 are integrated into one layer in the heating resistor 300, the ink penetration is effectively prevented because the firmness and the physical strength of the bonding between the components compared with the prior art are improved. Therefore, the requirement for the protective layer 208 can be appropriately reduced according to the application needs. By configuring the recess of the present disclosure, the ink is less blocked by the protective layer 208 than the prior art. Therefore, the ink can be closer to the heating resistance layer 205, so that the heating resistance layer 205 does not need to be supplied with an excessive voltage (or current) to heat the ink to generate bubbles and squeeze the ink to generate ink droplets. Moreover, since the use of energy consumption is less, the heating resistance layer 205 is less damaged by the power pulse when the power is repeatedly switched on and off, thereby achieving a long service life and energy saving effect. On the other hand, the height H of the recesses is defined by the first surface A on the upper end of the protective layer 208 and the second surface B on the upper end of the dielectric layer 203. Notably, the range of the height H is subject to change or modification by those skilled in the art after reading the present disclosure according to the actual printing range, the resolution, the cost and the energy saving of the inkjet chip structure 200. It is explained here in advance.

In the embodiment, the protective layer 208 is configured with an appropriate number of layers according to the practical requirements. In an embodiment, the protective layer 208 includes two layers. Preferably but not exclusively, as shown in FIG. 2 and FIG. 3, the protective layer includes a first protective layer 208A and a second protective layer 208B. The first protective layer 208A and the second protective layer 208B are stacked in sequence from bottom to top. The upper end of the protective layer 208, i.e., the upper end of the second protective layer 208B is a first surface A. Notably, the plurality of protective layers 208 described in the present disclosure, i.e., FIG. 4C, may be configured with a first protective layer 208A, a second protective layer 208B, a third protective layer 208C, . . . an Nth protective layer according to the practical requirements, and may be collectively referred to as the protective layer 208. Preferably but not exclusively, the protective layer 208 includes three layers. After reading the present disclosure, those skilled in the art can set an appropriate number of protective layers 208 (such as the aforementioned N layers) as needed. That is, the first protective layer 208A, the second protective layer 208B, the third protective layer 208C, . . . the Nth protective layer. The upper end of the protective layer 208, i.e., the upper end of the third protective layer 208C is the first surface A. Moreover, the material of the first protective layer 208A is different from that of the remaining N-1 layers.

In the embodiment, the above-mentioned signal terminal can be an external signal terminal from outside the inkjet chip structure 200, or an internal signal terminal integrated into the inkjet chip structure 200. In an embodiment of the present disclosure, in case of that the signal terminal is an internal signal terminal, the internal signal terminal is a control transistor 209, and electrically connected to the control layer 207, so that the control transistor 209 can control the heating resistance layer 205 to heat the ink during the printing process. In an embodiment, the control layer 207 is electrically connected to the control transistor 209, so that the control transistor 209 can control the heating resistance layer 205 to heat the ink during the printing process. Preferably but not exclusively, the control transistor 209 is a metal-oxide semiconductor field-effect transistor (MOSFET). In an embodiment, the control transistor 209 is a metal-oxide semiconductor field-effect transistor (MOSFET), and the control transistor 209 includes a source S, a drain D and a gate G. The source S and the drain D are embedded in the substrate layer 201, and the gate G is arranged on the substrate layer 201 to control the source S and the drain D for opening and closing, so that the control transistor 209 controlled and operated. Preferably but not exclusively, in an embodiment of the present disclosure, the gate G further includes a second oxide layer 209A and a polysilicon layer 209B. The second oxide layer 209A and the polysilicon layer 209B are sequentially stacked on the substrate layer 201.

Preferably but not exclusively, in an embodiment, the control transistor 209 is a MOSFET, and the control transistor 209 is selected from an N-type metal-oxide semiconductor field-effect transistor (N-MOSFET) or a P-type metal-oxide semiconductor field-effect transistor (P-MOSFET). In other embodiments, the inkjet chip structure 200 includes a plurality of control transistors 209, which can be the MOSFET described in the present disclosure and selected from any combination of N-MOSFET or P-MOSFET.

Preferably but not exclusively, in an embodiment, the control transistor 209 is the MOSFET, and the polysilicon layer 209B of the gate G, the heating resistance layer 205 and the conductive layer 204 are made of the same material, such as a polysilicon material (polycrystalline silicon), but have different doping ratios. In the embodiment, the heating structure of two-layer inclined step structure in the inkjet chip structure 200 is improved based on the requirements. The gate G, the heating resistance layer 205 and the conductive layer 204 have differences in resistance values that need to be adjusted individually according to the practical requirements. In the process of manufacturing the heating resistance layer 205 and the conductive layer 204 in the inkjet chip structure 200, the polysilicon material is formed on the first oxide layer 202. Then, the size and position of the polysilicon material are defined by photoresist masking to form the heating resistance layer 205. Finally, the unshielded area of the polysilicon material is doped by ion implantation, ion diffusion or other methods to improve the conductivity to form the conductive layer 204. The heating resistance layer 205 and the conductive layer 204 are formed at the same time and located in an identical layer (i.e., the heating resistance layer 205 and the conductive layer 204 are disposed adjacent to each other and located at the same horizontal position). In this way, the problem of an inclined step-like shape at the interface between the two layers respectively produced by sputtering and etching in the conventional structure can be avoided.

Furthermore, please refer to FIG. 3. In the embodiment, the heating resistance layer 205 in the thermal resistor 300 is a heater area for heating the ink required for inkjet printing. Preferably but not exclusively, in the embodiment, the conductive layer 204 is located adjacent to both sides of the heating resistance layer 205. In the process of doping polysilicon material, the doping concentration can be respectively changed in a high-low-high manner to form a structure with better conductivity, higher impedance and better conductivity. That is, the structure of conductive layer 204-the heating resistance layer 205-the conductive layer 204. In this way, the conductive layer 204 and the heating resistance layer 205 can be located on the identical layer as described above. Thereby, the inclined step-like problems of the two layers are eliminated, and the mechanical strength is improved. Thereafter, when the subsequent dielectric layer 203 is formed on the conductive layer 204 and the heating resistance layer 205, and covers the first oxide layer 202, the dielectric layer 203 and the protective layer 208 are more firmly bonded. Accordingly, it has better mechanical strength, service life and reliability, and also makes the inkjet chip structure 200 more stable during operation. Moreover, it prevents the film thereof from breaking and causing ink to seep. Thereby, the purpose of improving the printing performance of the subsequent simultaneous printing, such as the number of spray points control, the printing mode processing, the brightness control and the saturation control.

In the embodiment, a plurality of contact layers 206 of the inkjet chip structure 200 are disposed on the conductive layer 204, the source S and the drain D of the control transistor 209, and electrically connected to the control layer 207 served as a conductor, so that the control transistor 209 controls the heating resistance layer 205 to heat the ink during the printing process. In one embodiment of the present disclosure, the dielectric layer 203 can be formed by using a contact hole technology. Preferably but not exclusively, the contact layer 206 is defined by photolithography and etching to facilitate the connection of the control layer 207 for the conductive wire. Preferably but not exclusively, the control layer 207 is made of a material selected from aluminum copper alloy (AlCu) or gold (Au) according to the practical requirements. In the protective layer 208, the required conductive through-holes (not shown) can also be defined through the via hole technology according to the practical requirements. The material of the conductive wire can also be selected from aluminum copper alloy (AlCu) or gold (Au).

Preferably but not exclusively, in the embodiment, the heating resistance layer is made of a material selected from the group consisting of polycrystalline silicon, tantalum aluminide (TaAl), tantalum (Ta), tantalum nitride (TaN), tantalum disilicide (Si₂Ta), carbon (C), silicon carbide (SiC), indium tin oxide (ITO), zinc oxide (ZnO), cadmium sulfide (CdS), hafnium diboride (HfB₂), titanium tungsten (TiW) alloy, titanium nitride (TiN) and a combination thereof.

Preferably but not exclusively, in the embodiment, the control layer 207 is made of a material selected from the group consisting of aluminum-copper (AlCu) alloy, gold (Au), aluminum-silicon alloy (AlSi), palladium (Pd), palladium-silver alloy (PdAg), platinum (Pt), aluminum-silicon-copper (AlSiCu), niobium (Nb), vanadium (V), hafnium (Hf), titanium (Ti), zirconium (Zr), yttrium (Y) and a combination thereof.

Preferably but not exclusively, in an embodiment, the first oxide layer 202 is an electrical-insulation and thermal-insulation material, and the electrical-insulation and thermal-insulation material is one selected from one of field oxide (FOX), silicon dioxide (SiO₂), silicon nitride (Si₃N₄), phosphorus silicon glass (PSG) and a combination thereof.

In the embodiment, the protective layer 208 can be configured with an appropriate number of layers according to the practical requirements. In an embodiment, the protective layer 208 includes a first protective layer 208A and a second protective layer 208B. Preferably but not exclusively, the first protective layer 208A is a passivation material, and the passivation material is one selected from the group consisting of silicon nitride (Si₃N₄), silicon dioxide (SiO₂), titanium dioxide (TiO₂), hafnium dioxide (HfO₂), zirconium dioxide (ZrO₂), tantalum pentoxide (Ta₂O₅), rhenium heptoxide (Re₂O₇), niobium pentoxide (Nb₂O₅), uranium pentoxide (U₂O₅), tungsten trioxide (WO₃), silicon oxynitride (Si₄O₅N₃), silicon carbide (SiC) and a combination thereof. The second protective layer 208B is made of a metal material, and the metal material is one selected from the group consisting of tantalum (Ta), tantalum nitride (TaN), titanium nitride (TiN), tungsten nitride (TiW) and a combination thereof.

Preferably but not exclusively, in the embodiment, the inkjet chip structure 200 is allowed to print at a resolution (Dots Per Inch, the number of dots or ink drops per inch) ranged from 150 DPI to 48000 DPI.

From the above descriptions, the present disclosure provides an inkjet chip structure. By improving the two-layer inclined step structure at the junction of the heating resistance layer and the conductive layer in the conventional inkjet chip heating structure according to the prior art, the heating resistance layer and the conductive are arranged on an identical layer. to make them located on the same layer. At the same time, the size specifications of the inkjet chip and the recesses are optimized based on the requirements to balance the energy saving during printing and the yield during production. Compared with the conventional technology, the mechanical strength, the service life and the reliability of the inkjet chip structure of the present disclosure are increased. Under this condition, it allows to reduce the use of the protective layer and form (open) a recess thereon to improve the efficiency and the energy consumption of the heating resistance layer during heating the ink. In addition, the signal terminal for controlling the inkjet chip is integrated internally. That is, the architecture combined with the MOSFET control element can also benefit from the operational stability brought by the increased mechanical strength. The printing performance of the inkjet chip structure in subsequent simultaneous printing, such as the number of dots controlled, printing mode processing, brightness control and saturation control, can be further improved. The requirements for manufacturing processes and the additional manufacturing costs are sufficiently reduced. The present disclosure has great industrial applicability and meets the patent requirements, so as to be filed.

While the invention has been described in terms of what is presently considered to be the most practical and preferred embodiments, it is to be understood that the invention is not need to be limited to the disclosed embodiments. On the contrary, it is intended to cover various modifications and similar arrangements included within the spirit and scope of the appended claims so as to encompass all such modifications and similar structures.

What is claimed is:

1. An inkjet chip structure, comprising:
a substrate layer;
a heating resistor, disposed on the substrate layer, wherein the heating resistor further comprises:
a heating resistance layer for heating an ink; and
a dielectric layer encapsulating the heating resistance layer therein;
a protective layer covering the heating resistor and comprising a recess; and
a plurality of contact layers electrically connected to the heat resister, wherein the plurality of contact layers are rectangular and disposed around the heating resistor, at least two of the plurality of contact layers are arranged in each direction from the heating resistor, and each of the plurality of contact layers has one side length with a fixed size.

2. The inkjet chip structure according to claim 1, wherein the heating resistor further comprises:
a first oxide layer, disposed on the substrate layer;
a conductive layer, disposed adjacent to and in contact with the heating resistance layer, located at an identical horizontal position of the heating resistance layer and covering a partial surface of the first oxide layer, wherein the heating resistance layer and the conductive layer are encapsulated in the dielectric layer; and
a control layer partially covering the dielectric layer and electrically connected to an external signal terminal or an internal signal terminal to control the heating of the ink.

3. The inkjet chip structure according to claim 1, wherein a distance is formed from a bottom of the recess to a top of the heating resistance layer, and the distance is ranged from 1.5×10⁻⁷ m to 1.4×10⁻⁶ m.

4. The inkjet chip structure according to claim 1, wherein the recess includes a plurality of recesses, and a ratio of a total surface area of the plurality of recesses to a surface area of the inkjet chip structure is less than 20%.

5. The inkjet chip structure according to claim 1, wherein the recess comprises a plurality of recesses, and a ratio of a total surface area of the plurality of recesses to a surface area of the inkjet chip structure is less than 25%.

6. The inkjet chip structure according to claim 1, wherein the protective layer comprises a plurality of protective layers, the plurality of protective layers further comprises a first protective layer directly disposed on the heating resistor, and the first protective layer is an insulation material.

7. The inkjet chip structure according to claim 2, wherein the internal signal terminal is a control transistor electrically connected to the control layer.

8. The inkjet chip structure according to claim 7, wherein the plurality of contact layers are disposed on the conductive layer and the control transistor, and electrically connected to the control layer.

9. The inkjet chip structure according to claim 8, wherein the control transistor is a metal-oxide semiconductor field-effect transistor (MOSFET).

10. The inkjet chip structure according to claim 9, wherein the MOSFET further comprises a source, a drain and a gate, wherein the source and the drain are embedded in the substrate layer, and the gate is arranged on the substrate layer to control the source and the drain for opening and closing, so that the MOSFET is operated.

11. The inkjet chip structure according to claim 10, the control layer is made of a material selected from aluminum copper alloy (AlCu) or gold (Au).

12. The inkjet chip structure according to claim 1, the inkjet chip structure is allowed to print at a resolution ranged from 150 DPI to 48000 DPI.

13. The inkjet chip structure according to claim 1, wherein the heating resistance layer is made of a material selected from the group consisting of polycrystalline silicon, tantalum aluminide (TaAl), tantalum (Ta), tantalum nitride (TaN), tantalum disilicide (Si₂Ta), carbon (C), silicon carbide (SiC), indium tin oxide (ITO), zinc oxide (ZnO), cadmium sulfide (CdS), hafnium diboride (HfB₂), titanium tungsten (TiW) alloy, titanium nitride (TiN) and a combination thereof.

14. The inkjet chip structure according to claim 1, wherein the protective layer further comprises a first protective layer and a second protective layer, and the first protective layer and the second protective layer are sequentially stacked from bottom to top in the inkjet chip structure.

15. The inkjet chip structure according to claim 14, wherein the first protective layer is made of a material selected from the group consisting of silicon nitride (Si₃N₄), silicon dioxide (SiO₂), titanium dioxide (TiO₂), hafnium dioxide (HfO₂), zirconium dioxide (ZrO₂), tantalum pentoxide (Ta₂O₅), rhenium heptoxide (Re₂O₇), niobium pentoxide (Nb₂O₅), uranium pentoxide (U₂O₅), tungsten trioxide (WO₃), silicon oxynitride (Si₄O₅N₃), silicon carbide (SiC) and a combination thereof.

16. The inkjet chip structure according to claim 14, wherein the second protective layer is made of a metal material, and the metal material is one selected from the group consisting tantalum (Ta), tantalum nitride (TaN), titanium nitride (TiN), tungsten nitride (TiW) and a combination thereof.
